(19) United States
(12) Patent Application Publication
(10) Pub. No.: US 2013/0346779 A1
(43) Pub. Date: Dec. 26, 2013

(54) WAKING DEVICE AND ELECTRONIC APPARATUS

(71) Applicant: HON HAI PRECISION INDUSTRY CO., LTD., New Taipei (TW)

(72) Inventor: CHIH-CHUN CHANG, New Taipei (TW)

(73) Assignee: HON HAI PRECISION INDUSTRY CO., LTD., New Taipei (TW)

(21) Appl. No.: 13/869,276

(22) Filed: Apr. 24, 2013

(30) Foreign Application Priority Data
Jun. 25, 2012 (TW) 101122704

(51) Int. Cl. G06F 1/32

(52) U.S. Cl. CPC G06F 1/3234
USPC 713/323

(57) ABSTRACT

A waking device for controlling an electronic device connected to the waking device from a first state to a second state. The electronic device receives signals from a portable external device and is unable to execute a corresponding operation based on the received signal. The waking device comprises storage with a predetermine parameter, a processing module, and a triggering module connected to the processing module. The processing module processes the received signal from the portable external device to obtain a waking parameter and compares the waking parameter with the predetermined parameter in the storage. When the waking parameter matches the predetermined parameter, the processing module generates a waking signal, and the triggering module controls the electronic device to switch from the first state to the second state in response to the waking signal, the electronic device is enable to execute a corresponding operation based on the received signal.

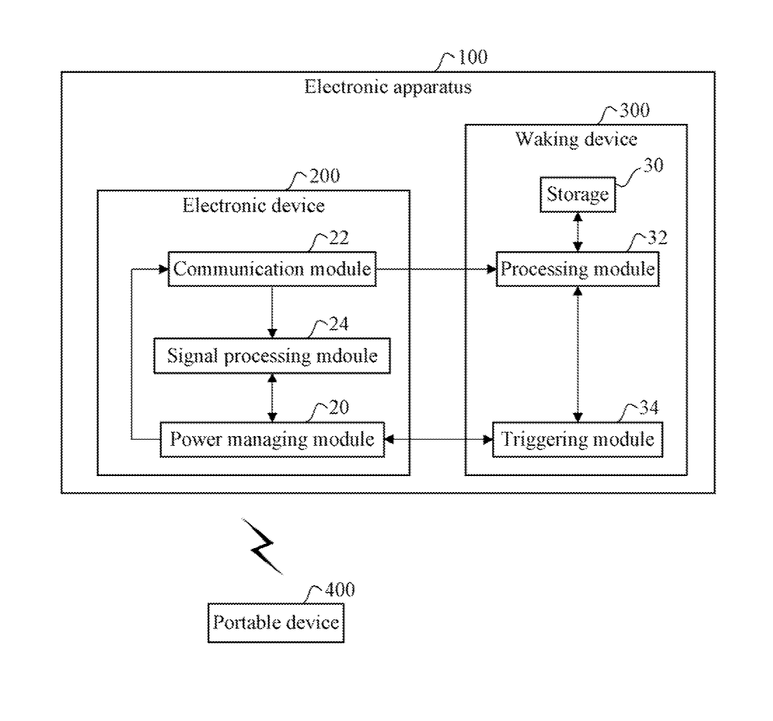

### BACKGROUND

1. Technical Field

The present disclosure relates to electronic apparatuses, particularly to an electronic apparatus for waking an electronic device via a portable device.

2. Description of Related Art

A portable device, such as mobile phone or panel computer, is capable of controlling an electronic device to execute different functions via a WiFi module. However, when the WiFi module in electronic device is powered off, the portable device may not be able to power-on the electronic device.

Therefore, there is room for improvement in the art.

### BRIEF DESCRIPTION OF THE FIGURE

Many aspects of the embodiments can be better understood with reference to the following drawing. The components in the drawing are not necessarily drawn to scale, the emphasis instead being placed upon clearly illustrating the principles of the electronic apparatus.

The FIGURE is a block diagram of an electronic apparatus in accordance with an embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawing.

The FIGURE shows an electronic apparatus 100 of the embodiment. The electronic apparatus 100 communicates with a portable external device 400, and switches between a first state and a second state based on the signal from the portable external device 400. The electronic apparatus 100 includes an electronic device 200 and a waking device 300 connected to the electronic device 200. In the embodiment, the electronic device 200 is a television, and the portable external device 400 is a mobile phone. In other embodiments, the waking device 300 can be a part of the electronic device 200.

The electronic device 200 is capable of switching between the first state and the second state. In the embodiment, the first state is a standby state, and the second state is a power-on state. The electronic device 200 includes a power managing module 20, a communication module 22, and a signal processing module 24.

The power managing module 20 is connected with the communication module 22 and the signal processing module 24. When the electronic device is in the first state, the power managing module 20 provides a first voltage to the communication module 22; when the electronic device 200 is in the second state, the power managing module 20 provides the first voltage to the communication module 22 and provides a second voltage for the signal processing module 24.

The communication module 22 is connected to the power managing module 20, the signal processing module 24, and the waking device 300. When being powered by the first voltage, the communication module 22 receives signals from the portable external device 400 and transmits the received signals to the signal processing module 24 wired or wirelessly. In the embodiment, communication module 22 is an antenna; the received signal is an RF signal.

The signal processing module 24 is connected between the power managing module 20 and the communication module 22. When being powered by the second voltage, the signal processing module 24 demodulates and decodes the received signal to generate a control signal for controlling the electronic device 200 to execute a corresponding operation. For example, the demodulated and decoded signal can control the electronic device 200 to switch from the second state to the first state. In the embodiment, the signal processing module 24 is a WiFi module.

The waking device 300 presets a predetermined parameter. The waking device 300 processes the received signals from the communication module 22 to obtain a waking parameter, and switches the electronic device 200 from the first state to the second state when the waking parameter matches the predetermined parameter. In the embodiment, the waking device 300 is powered by the electronic device 200. In the other embodiments, the waking device 300 can be powered by an internal battery (not shown) of the waking device 300.

The waking device 300 includes storage 30, a processing module 32, and a triggering module 34.

The storage 30 stores the predetermined parameter.

The processing module 32 is electrically connected to the communicating module 22. The processing module 32 processes the received signal from the communicating module 22 to obtain the waking parameter, then compares the waking parameter with the predetermined parameter extracted from the storage 30, and then generates a waking signal when the waking parameter of the received signal matches the predetermined parameter. In the embodiment, the waking parameter can be the power of the received signal, or the voltage of the received signal, or the current of the received signal, or the total number of the received signals, or the recorded time from a time point when the communication module 22 receives signal from the portable external device 400, for example.

The triggering module 34 controls the electronic device 200 to switch from the first state to the second state in response to the waking signal.

In another embodiment, the predetermined parameter is a predetermined signal. The processing module 32 demodulates and decodes the received signal in the communication module 22 to generate a processed signal, and compares the processed signal with the predetermined signal in the storage 30. When the processed signal matches the predetermined signal, the processing module 32 generates a waking signal. The triggering module 34 controls the electronic device 200 to switch from the first state to the second state.

In use, the electronic apparatus 100 can be switched from the standby state into the power-on state via the received signal from the portable external device 400.

While various embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A waking device for controlling an electronic device connected to the waking device to switch from a first state to a second state, the electronic device receives signals from a portable external device and unable to execute a corresponding operation based on the received signal in the first state, the waking device comprising:
a storage storing a predetermine parameter;
a processing module configured to process the received signal from the portable external device to obtain a waking parameter and compare the waking parameter with the predetermined parameter in the storage; and
a triggering module connected to the processing module and the electronic device;
wherein when the waking parameter matches the predetermined parameter, the processing module generates a waking signal, the triggering module controls the electronic device to switch from the first state to the second state in response to the waking signal, the electronic device is enabled to execute the corresponding operation based on the received signal in the second state.

2. The waking device of claim 1, wherein the waking device is powered by the electronic device.

3. The waking device of claim 1, wherein the waking parameter is the power of the received signal.

4. The waking device of claim 1, wherein the waking parameter is the voltage of the received signal.

5. The waking device of claim 1, wherein the waking parameter is the current of the received signal.

6. The waking device of claim 1, wherein the waking parameter is the total number of the received signals.

7. The waking device of claim 1, wherein the waking parameter is the recorded time from a time point when the electronic device receives the signal from the portable external device.

8. The waking device of claim 1, wherein the processing module demodulates and decodes the received signal from the portable external device to obtain a processed signal, and then compares the processed signal with the predetermined parameter.

9. The waking device of claim 8, wherein the electronic device comprises a communication module, and a signal processing module; the communication module receives signals from the portable external device and transmits the received signal to the signal processing module; when the electronic device in the first state, the signal processing module is unable to demodulate and decode the received signal; when the electronic device is in the second state, the signal processing module is enabled to demodulate and decode the received signal.

10. The waking device of claim 9, wherein the electronic device further comprises a power managing module; when the electronic device in the first state, the power managing module provides a first voltage for the communication module; when the electronic device in the second state, the power managing module further provides a second voltage for the signal processing module; the communication module is powered by the first voltage; the signal processing module is powered by the second voltage.

11. An electronic apparatus comprising:
an electronic device capable of receiving signals from a portable external device and switching between a first state and a second state, wherein in the first state the electronic device is unable to execute a corresponding operation based on the received signal from the portable external device; and
a waking device with a predetermined parameter and connected to the electronic device;
wherein the waking device process the received signal in the electronic device to obtain a waking parameter and compares the waking parameter with the predetermined parameter; when the waking parameter matches the predetermined parameter, the waking device generates a waking signal for controlling the electronic device to switch from the first state to the second state; in the second state the electronic device is enable to execute a corresponding operation based on the received signal from the portable external device.

12. The electronic apparatus of claim 11, wherein the waking parameter is the power of the received signal.

13. The electronic apparatus of claim 11, wherein the waking parameter is the voltage of the received signal.

14. The electronic apparatus of claim 11, wherein the waking parameter is the current of the received signal.

15. The electronic apparatus of claim 11, wherein the waking parameter is the total number of the received signals.

16. The electronic apparatus of claim 11, wherein the waking parameter is the recorded time from a time point when the electronic device receives the signal from the portable external device.

17. The electronic apparatus of claim 11, wherein the processing module demodulates and decodes the received signal from the portable external device to obtain a processed signal, and then compares the processed signal with the predetermined parameter.

18. The electronic apparatus of claim 11, wherein the electronic device comprises a communication module, and a signal processing module; the communication module receives signals from the portable external device and transmits the received signals to the signal processing module; when the electronic device in the first state, the signal processing module is unable to demodulate and decode the received signal; when the electronic device is in the second state, the signal processing module is enabled to demodulate and decode the received signal.

19. The electronic apparatus of claim 11, wherein the waking device is powered by the electronic device.
